(19) United States
(12) Patent Application Publication
(10) Pub. No.: US 2014/0270208 A1
(43) Pub. Date: Sep. 18, 2014

(54) MONITORING OF SPEAKER IMPEDANCE TO DETECT PRESSURE APPLIED BETWEEN MOBILE DEVICE AND EAR

(71) Applicant: CIRRUS LOGIC, INC., Austin, TX (US)

(72) Inventors: Antonio John Miller, Austin, TX (US); Jie Su, Austin, TX (US)

(73) Assignee: Cirrus Logic, Inc., Austin, TX (US)

(21) Appl. No.: 13/844,602

(22) Filed: Mar. 15, 2013

(51) Int. Cl. H04R 29/00

(52) U.S. Cl. CPC H04R 29/001
USPC 381/59

(57) ABSTRACT

Coupling between a user's ear and a speaker of a mobile device may be determined by measuring an impedance of the speaker. When the user presses the mobile device against the user's ear, the speaker impedance changes as a result of loading in the speaker's acoustic radiation impedance. The speaker impedance change may be correlated with the force applied by the user to the mobile device. The measured speaker impedance may be provided as feedback to an adaptive noise cancellation (ANC) algorithm to adjust the output at the speaker. For example, when the mobile device is removed from the user's ear, the ANC algorithm may be muted.

### FIELD OF THE DISCLOSURE

The instant disclosure relates to mobile devices. More specifically, this disclosure relates to audio output of mobile devices.

### BACKGROUND

Mobile devices are carried by a user throughout most or all of a day. During the day, the user may encounter many different environments, each with a different background noise characteristic and other acoustic effects. Mobile devices employ noise cancelling to take into account the environmental changes and improve the user's experience while using the mobile device. However, the performance of noise cancelling systems vary with how closely a speaker of the mobile device is placed against the user's ear, because the coupling between the user's ear and the speaker varies with distance.

### SUMMARY

An impedance of a speaker of a mobile device varies due to objects interfering with the speaker's acoustic radiation field. For example, when a user places the mobile device closer to the user's ear, the speaker impedance increases. The impedance of the speaker may be measured by the mobile device to determine a pressure applied by the user between the mobile device and the user's ear. The impedance may be applied to an adaptive noise cancellation (ANC) circuit to adjust processing of an audio signal for playback through the speaker. The changes in impedance vary proportionally to the pressure applied by the user to place the mobile device against his ear and thus vary proportionally to a distance between the speaker and the user's ear canal. In one example, the impedance of a speaker may range from 5 ohms to 11 ohms depending on the pressure applied between the speaker and the user's ear.

According to one embodiment, a method may include calculating an impedance of a speaker of a mobile device. The method may also include determining a force applied by a user of the mobile device that causes contact between the mobile device and the user based, at least in part, on the calculated impedance. In certain embodiments, the impedance is an acoustic radiation impedance.

The method may also include applying a voltage to the speaker, and measuring a current through the speaker, in which the step of calculating the impedance comprises calculating the impedance based at least in part on the applied voltage and the measured current; adjusting an adaptive noise cancellation (ANC) algorithm based, at least in part, on the determined force; receiving an audio signal from an error microphone, in which the step of adjusting the ANC algorithm comprises adjusting the ANC algorithm based, at least in part, on the error microphone audio signal; and/or linearizing an output of the speaker based, at least in part, on the calculated impedance.

According to another embodiment, an apparatus may include a speaker. The apparatus may also include an amplifier coupled to the speaker. The apparatus may further include a processor coupled to the amplifier. The processor may be configured to execute the steps comprising calculating an impedance of the speaker and determining an environmental load of the speaker based, at least in part, on the calculated impedance.

In certain embodiments, the apparatus may be a mobile device; the environmental load may be proportional to a force, applied by a user of the mobile device, that causes contact between the mobile device and the user; the amplifier may be configured to apply a voltage to the speaker and measure a current through the speaker, and the processor may be configured to calculate the impedance based, at least in part, on the applied voltage and the measured current; the processor may be a digital signal processor (DSP) and the digital signal processor may be configured to adjust an adaptive noise cancellation (ANC) algorithm based, at least in part, on the determined force; and/or the processor may be further configured to linearize an output of the speaker based, at least in part, on the calculated impedance.

The apparatus may also include an error microphone coupled to the digital signal processor, in which the digital signal processor is further configured to adjust the ANC algorithm based, at least in part, on an audio signal received from the error microphone

According to yet another embodiment, a computer program product includes a non-transitory computer readable medium comprising code to execute the steps comprising calculating an impedance of a speaker and determining an environmental load of the speaker based, at least in part, on the calculated impedance. In certain embodiments, the environmental load may be proportional to a force, applied by a user of the mobile device that causes contact between the mobile device and the user.

The medium may also include code to detect, based at least in part on the determined force, when the mobile device is removed from an ear of the user; code to adjust an adaptive noise cancellation (ANC) algorithm based, at least in part, on the determined force; and/or code to linearize an output of the speaker based, at least in part, on the calculated impedance.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a cross-section illustrating a mobile device with speaker impedance monitoring according to one embodiment of the disclosure.

FIG. 2 is a block diagram illustrating speaker impedance monitoring according to one embodiment of the disclosure.

FIG. 3 is a graph illustrating speaker impedance over time based on various user placements of the mobile device according to one embodiment of the disclosure.

FIG. 4 is a block diagram illustrating a noise canceling system according to one embodiment of the disclosure.

FIG. 5 is a flow chart illustrating a method for adaptive noise cancellation (ANC) in a mobile device according to one embodiment of the disclosure.

FIG. 6 is a block diagram of an adaptive noise cancellation (ANC) circuit according to one embodiment of the disclosure.

FIG. 7 is a graph of a response against pressure applied between the mobile device and the user's ear according to one embodiment of the disclosure.

FIG. 8 is a graph of a response as a function of frequency for different levels of ear pressure according to one embodiment of the disclosure.

FIG. 9 is a flow chart illustrating a method for adapting adaptive noise cancellation algorithms based on ear pressure according to one embodiment of the disclosure.

### DETAILED DESCRIPTION

FIG. 1 is a cross-section illustrating a mobile device with speaker impedance monitoring according to one embodiment of the disclosure. A mobile device 102 may be placed near a user's ear 160. The mobile device 102 may be, for example, a mobile phone, a tablet computer, a laptop computer, or a wireless earpiece. The mobile device 102 may include a speaker 104, such as a transducer, driven by an amplifier 122 of a circuit 120. The speaker 104 may generate an acoustic sound field 150 near the mobile device 102. The user's ear 160 translates the acoustic sound field 150 into recognizable sounds for the user. For example, the acoustic sound field 150 may include speech conversations occurring during a phone call, playback of a voice mail message, playback of ring tones, and/or playback of audio or video files. The amplifier 122 may receive audio signals from a processor 124 of the circuit 120, such as a digital signal processor (DSP).

The mobile device 102 may also include a near-speech microphone 136, an error microphone 134, and a reference microphone 132. Each of the microphones 132, 134, and 136 receive audible sounds fields and translate the acoustic sound fields into electrical signals for processing by the circuit 120. For example, the near-speech microphone 136 may receive speech during a conversation occurring during a phone call. In another example, the error microphone 134 may receive the acoustic sound field 150 generated by the speaker 104. In a further example, the reference microphone 132 may be positioned away from a typical position of a user's mouth and may measure an ambient acoustic environment.

One apparatus for measuring a speaker impedance includes a resistor for measuring current. FIG. 2 is a block diagram illustrating speaker impedance monitoring according to one embodiment of the disclosure. The speaker 104 may be coupled to a voltage source 202 of the amplifier 122. The speaker 104 may have an impedance 206 proportional to loading of the acoustic sound field 150. A resistor 204 may be coupled in series with the speaker 104, such that a current passing through the resistor 204 is proportional to a current passing through the speaker 104. A voltmeter 208 may be coupled in parallel with the resistor 204 to measure a voltage across the resistor 204. The current passing through the resistor 204, and thus the speaker 104, may be calculated by multiplying the resistance value of the resistor 204 with the measured voltage at the voltmeter 208. The current may be calculated by a processor, such as the processor 124. The impedance 206 of the speaker 104 may be calculated, by the processor 124, from the voltage value at the voltage source 202, the resistance value of the resistor 204, and the voltage across the resistor 204 measured by the voltmeter 208.

The voltage at the speaker 104, V_{T}, may be calculated by dividing the voltage of the voltage source 202, V_{S}, across the resistor 204 and the speaker 104 according to a voltage ladder. For example, the impedance 206, Z_{L}, may be calculated from the current, I, through the resistor 204, and the value of the resistor 204, R.

Speaker impedance, Z_{L}, varies with the pressure applied by the user to place the mobile device against the user's ear. FIG. 3 is a graph illustrating speaker impedance over time based on various user placements of the mobile device according to one embodiment of the disclosure. A graph 300 plots current on a y-axis 306 against time on an x-axis 304. The x-axis 304 is divided into time periods 312, 314, 316, and 318 illustrating different events determined by the speaker impedance. A current line 302 illustrates a baseline pressure applied during the time period 312. During the time period 314, the current line 302, and thus speaker impedance, increases proportional to increasing pressure applied by the user to place the mobile device against the user's ear. During time period 316, the user removes the mobile device from his/her ear resulting in a decrease in the current line 302, and thus speaker impedance. During a time period 318, the user places the mobile device on the user's cheek resulting in an increase in current, and thus speaker impedance.

A speaker impedance may be provided to an adaptive noise cancellation (ANC) system for adapting the noise control system. FIG. 4 is a block diagram illustrating a noise canceling system according to one embodiment of the disclosure. A circuit 420 may receive input from the microphones 132, 134, and 136. Analog values from the microphones 132, 134, and 136 may be converted by analog-to-digital converters (ADCs) 421A, 421B, and 421C. The ADCs 421A, 421B, and 421C may be part of the noise control system or may be built into the microphones 132, 134, and 136, respectively. In one embodiment, the microphones 132, 134, and 136 are digital microphones, and no ADCs are placed between the digital microphones and the circuit 420.

The circuit 420 may also receive input from the speaker 104, such as an impedance value of the speaker 104. The impedance value may be calculated by the amplifier 122 and output to an analog-to-digital converter 421D, which converts the impedance value to a digital value for ANC circuit 430. In one embodiment, the speaker impedance output by the amplifier 122 is a digital value, and no analog-to-digital converter is present.

The ANC circuit 430 may generate an anti-noise signal, which is provided to a combiner 426. The anti-noise signal may be adjusted according to a force, or distance, between the user's ear and the speaker 104. For example, the anti-noise signal may be disabled when the user removes the phone from the user's ear. The removal of the phone from the user's ear may be detected when the speaker impedance falls below a threshold value.

The combiner 426 combines the anti-noise signal from the ANC circuit 430 with sound from the near speech microphone 136, internal audio 426, and audio signals received wirelessly through an antenna 428 and processed by a radio frequency (RF) circuit 422. The internal audio 426 may be, for example, ringtones, audio files, and/or audio portions of video files. Audio signals received through the antenna 428 may be, for example, streamed analog or digital audio signals and/or telephone conversations. The combiner 426 provides a single signal to a digital-to-analog converter (DAC) 423. The DAC 423 converts the digital signal of the combiner 423 to an analog audio signal for amplification by the amplifier 122 and output at the speaker 104.

FIG. 5 is a flow chart illustrating a method for adaptive noise cancellation in a mobile device according to one embodiment of the disclosure. A method 500 begins at block 502 with calculating an impedance of a speaker. The speaker impedance may be calculated by monitoring a current through the speaker and calculating an impedance of the speaker based on a known voltage value driving the speaker. The current monitoring may be performed in real-time during playback of an audio signal, such as during a voice conversation or during playback of audio files.

At block 504, a force applied by the user between the mobile device and the user's ear may be determined from the calculated impedance. The impedance of the speaker is proportional to a loading of the speaker. Higher force applied by the user between the mobile device and the user's ear increases the load on the speaker, which appears as an increase in impedance of the speaker. The force applied by the user may be proportional to the distance between the speaker and the user's ear canal.

At block 506, an adaptive noise cancellation algorithm is adjusted based, at least in part, on the determined force at block 504. For example, a control oversight algorithm may determine from the determined force that the user has removed the mobile device from the user's ear. When the off-ear condition is detected, the adaptive noise cancellation algorithm may be disabled. In another example, feedback regarding the speaker impedance may be provided to an adaptive noise cancellation algorithm to adjust the output of a speaker to compensate for the user's ear position. For example, output to the speaker may be adjusted to obtain linearization of the speaker audio output at high sound pressure levels (SPLs).

Additional details regarding the adaptive noise cancellation circuit are illustrated in FIG. 6. FIG. 6 is a block diagram of an adaptive noise cancellation circuit according to one embodiment of the disclosure. An adaptive filter 630 may be formed from a fixed filter 632A, having a response W_{FIXED}(z)_{,} and an adaptive portion 632B, having a response W_{ADAPT}(z) with outputs summed by a combiner 636B. The adaptive filter 630 may receive the reference microphone signal ref and may adapt a transfer function W(z)=W_{FIXED}(z)+W_{ADAPT}(z) to generate an anti-noise signal, which is provided to the combiner 426 that combines the anti-noise signal with the audio to be reproduced by the speaker. The response W(z) adapts to estimate a ratio P(z)/S(z), where S(z) is the response for an electro-acoustic path and P(z) is the response for an acoustic path. A controllable amplifier circuit 611 mutes or attenuates the anti-noise signal under certain non-ideal conditions, such as when the anti-noise signal is expected to be ineffective or erroneous due to lack of a seal between the user's ear and mobile device.

The coefficients of adaptive filter 632B may be controlled by a W coefficient control block 631, which may use a correlation of two signals to determine the response of the adaptive filter 632B to reduce the energy of the error, such as calculated by a least-mean square function, between the components of the reference microphone signal ref that are present in the error microphone signal err. The signals compared by the W coefficient control block 631 may be the reference microphone signal ref as shaped by a copy of an estimate SE_{COPY}(z) of the response of path S(z) provided by filter 634B and an error signal e(n) formed by subtracting a modified portion of a downlink audio signal ds from the error microphone signal err. By transforming the reference microphone signal ref with a copy of the estimate of the response of path S(z), SE_{COPY}(z), and adapting the adaptive filter 632B to reduce the correlation between the resultant signal and the error microphone signal err, the adaptive filter 632B adapts to the desired response of P(z)/S(z)−W_{FIXED}(z). Thus, response W(z) adapts to P(z)/S(z), resulting in a noise-cancelling error, which may be for example white noise.

The signal compared to the output of the filter 634B by the W coefficient control block 631 adds to the error microphone signal err an inverted amount of the downlink audio signal ds that is processed by the filter response 634A, SE(z), of which response SE_{COPY}(z) is a copy. By injecting an inverted amount of the downlink audio signal ds, the adaptive filter 632B may be prevented from adapting to the relatively large amount of downlink audio present in the error microphone signal err and by transforming that inverted copy of the downlink audio signal ds with the estimate of the response of path S(z). The downlink audio that is removed from the error microphone signal err before comparison may match the expected version of the downlink audio signal ds reproduced at the error microphone signal err, because the electrical and acoustical path of S(z) may be the path taken by the downlink audio signal ds to arrive at an error microphone. The filter 634B may have an adjustable response tuned to match the response of the adaptive filter 634A, such that the response of the filter 634B tracks the adapting of the adaptive filter 634A.

The adaptive filter 634A may include coefficients controlled by SE coefficient control block 633, which compares the downlink audio signal ds and the error microphone signal err after removal of the above-described filtered downlink audio signal ds that has been filtered by the adaptive filter 634A to represent the expected downlink audio delivered to an error microphone, and which has been removed from the output of the adaptive filter 634A by a combiner 636A. The SE coefficient control block 633 correlates the downlink speech signal ds with the components of downlink audio signal ds that are present in the error microphone signal err. The adaptive filter 634A is adapted to generate a signal from the downlink audio signal ds, and optionally the anti-noise signal combined by the combiner 636B during muting conditions, that when subtracted from the error microphone signal err, contains the content of error microphone signal err that is not due to the downlink audio signal ds. The overall energy of the error signal normalized to the overall energy of the response SE(z) is related to the pressure between the user's ear and mobile device, which may be determined by calculating the speaker impedance described above with reference to FIG. 5.

In one embodiment, an ear pressure indicator 637 may determine the ratio between E|e(N)|, which is the energy of the error signal generated by the combiner 636A and an overall magnitude of the response of SE(z): Σ|SEn(z)|. Ear pressure indication E|e(n)|/Σ|SEn(z)| may be only one example function of e(n) and SEₙ(z) that may be used to yield a measure of ear pressure. For example, Σ|SEₙ(z)| or ΣSEₙ(z)̂2, which are a function of only SE(z) may be alternatively used, because the response SE(z) changes with ear pressure.

In another embodiment, the ear pressure indicator 637 may receive the speaker impedance measurement and calculate an ear pressure based, at least in part, on the speaker impedance. As described above with reference to FIG. 3, the speaker impedance may be used to determine a force applied by the user between the mobile device and the user's ear. That force may be entered into an algorithm to determine ear pressure. The ear pressure indicator 637 may implement calculation of ear pressure based on the speaker impedance, the error signal, and/or SE(z).

The ear pressure indicator 637 may output a value, either digital or analog, proportional to the force applied by the user between the mobile device and the user's ear. A comparator 642 compares the output of the ear pressure indicator 637 with a first, low pressure, threshold V_{th,L}. If the output is below the threshold, indicating that ear pressure is below the normal operating range, such as when the mobile device is off the user's ear, then the ear pressure response logic 638 may be signaled to take action to prevent generation of undesirable anti-noise at the user's ear. Similarly, a comparator 644 compares the output of the ear pressure indicator 637 with a second, high pressure, threshold V_{th,H}, and if E|e(n)|/Σ|SEn(z)| is above the threshold, indicating that ear pressure is above the normal operating range, such as when the mobile device is pressed hard onto the user's ear, then the ear pressure response logic 638 may be signaled to take action to prevent generation of undesirable anti-noise at the user's ear.

FIG. 7 is a graph of a response against force between the mobile device and the user's ear according to one embodiment of the disclosure. As pressure increases between a mobile device and the user's ear, the response SE(z) increases in magnitude, which indicates an improved electro-acoustic path S(z), which is a measure of a degree of coupling between the speaker and the error microphone. A higher degree of coupling between the user's ear and the speaker is indicated when response SE(z) increases in magnitude, and conversely, a lower degree of coupling between the user's ear and the speaker is indicated when response SE(z) decreases in magnitude. Because the adaptive filter 632B of FIG. 6 adapts to the desired response of P(z)/S(z), as ear pressure is increased and response SE(z) increases in energy, less anti-noise is generated. Conversely, as the pressure between the ear and mobile device decreases, the anti-noise signal may increase in energy, because the user's ear is no longer highly coupled to the speaker and/or the error microphone.

FIG. 8 is a graph of response SE(z) as a function of frequency for different levels of ear pressure according to one embodiment of the disclosure. As illustrated in FIG. 7, as the pressure is increased between the mobile device and the user's ear, the response SE(z) increases in magnitude in the middle frequency ranges of the graph, which correspond to frequencies at which most of the energy for speech is located. The graphs shown in FIGS. 7 and 8 may be determined for individual mobile device designs using either a computer model, or a mock-up of a simulated user's head that allows adjustment of contact pressure between the user's ear and mobile device, which may also have a measurement microphone in simulated ear canal.

In general, ANC operates properly when the user's ear is coupled to the speaker. Because the speaker may be able to only generate a certain output level, such as 80 dB sound pressure level (SPL) in a closed cavity, once the mobile device is no longer in contact with the user's ear, the anti-noise signal may be ineffective and muted. At high coupling between the user's ear and the mobile device, such as when a large force is applied between the mobile device and the user's ear, the higher-frequency energy, such as between 2 kHz and 5 kHz, may be attenuated, which may cause noise boost due to response W(z) not adapting to the attenuated condition of the higher frequencies. When the ear pressure is increased, the anti-noise signal may not be adapted to cancel energies at the higher frequencies. The response W_{ADAPT}(z) may then be reset to a predetermined value, and adaptation of response W_{ADAPT}(z) may be frozen, such as by holding the coefficients of response W_{ADAPT}(z) at constant predetermined values. Alternatively, the overall level of the anti-noise signal may be attenuated, or a leakage of response W_{ADAPT}(z) of the adaptive filter 632B may be increased. Leakage of response W_{ADAPT}(z) of the adaptive filter 632B may be provided by having the coefficients of response W_{ADAPT}(z) return to a flat frequency response or a fixed frequency response.

Referring back to FIG. 6, when the comparator 642 indicates that the degree of coupling between the user's ear and mobile device has been reduced below a first, low pressure, threshold, the ear pressure response logic 638 may stop adaptation of the W coefficient control 631, and the amplifier 611 may be disabled to mute the anti-noise signal. When the comparator 644 indicates that the coupling between the user's ear and the mobile device has increased above a second, high pressure, threshold, the ear pressure logic 638 may increase leakage of the W coefficient control 631 or reset response W_{ADAPT}(z) and freeze adaptation of response W_{ADAPT}(z).

Alternatively, the ear pressure indicator 637 may be a multi-valued or continuous indication of different ear pressure levels, and the actions above may be replaced by applying an attenuation factor to the anti-noise signal in conformity with the level of ear pressure, so that when the ear pressure passes out of the normal operating range, between the first threshold and the second threshold, the anti-noise signal level is also attenuated by lowering the gain of the amplifier 611.

In one embodiment, the response W_{FIXED}(z) of the fixed filter 632A may be trained for high ear pressure. Then, the adaptive response of the adaptive filter 632B, response W_{ADAPT}(z), may be allowed to vary with ear pressure changes, up to the point that contact with the ear is minimal, at which point the adapting of response W(z) may be halted and the anti-noise signal may be muted, or the pressure on the ear is over a high threshold, at which time response W_{ADAPT}(z) may be reset and adaptation of response W_{ADAPT}(z) may be frozen, or the leakage may be increased. Additional details regarding ANC operation are disclosed in U.S. patent application Ser. No. 13/310,380 entitled “Ear-Coupling Detection and Adjustment of Adaptive Response in Noise-Canceling in Personal Audio Devices,” which is hereby incorporated by reference.

FIG. 9 is a flow chart illustrating a method for adapting adaptive noise cancellation algorithms based on ear pressure according to one embodiment of the disclosure. A method 900 begins at block 970 with computing an ear pressure indication from at least one of the error microphone signal, the SE(z) coefficients, and/or the speaker impedance. At block 972, it is determined if the ear pressure is lower than a first threshold. If so, an off-ear event is detected, and the method 900 continues to block 974 to stop adapting response W(z) and/or mute the anti-noise signal. If not, the method 900 continues to block 976.

At block 976, it is determined whether the ear pressure is above a second threshold, higher than the first threshold. If so a hard-pressure event is detected, and the method 900 continues to block 978 to increase leakage of the response W(z) and/or reset and freeze the adaptive portion of response W(z). If not, then normal operation is continued at block 980, during which response W(z) adapts to the ambient audio environment and the anti-noise signal is output to the speaker.

At block 982, it is determined whether the ANC is terminated or the mobile device is shut down. If not, then the method 900 repeats, such as by returning to block 970 and repeating blocks 972 and/or 976. If the determination is yes at block 982, then the method 900 terminates.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
calculating an impedance of a speaker of a mobile device; and
determining a force, applied by a user of the mobile device, that causes contact between the mobile device and the user based, at least in part, on the calculated impedance.

2. The method of claim 1, in which the impedance is an acoustic radiation impedance.

3. The method of claim 1, further comprising detecting, based at least in part on the determined force, when the mobile device is removed from an ear of the user.

4. The method of claim 1, further comprising:
applying a voltage to the speaker; and
measuring a current through the speaker,
in which the step of calculating the impedance comprises calculating the impedance based at least in part on the applied voltage and the measured current.

5. The method of claim 1, further comprising adjusting an adaptive noise cancellation (ANC) algorithm based, at least in part, on the determined force.

6. The method of claim 5, further comprising receiving an audio signal from an error microphone, in which the step of adjusting the ANC algorithm comprises adjusting the ANC algorithm based, at least in part, on the error microphone audio signal.

7. The method of claim 1, further comprising linearizing an output of the speaker based, at least in part, on the calculated impedance.

8. An apparatus, comprising:
a speaker;
an amplifier coupled to the speaker;
a processor coupled to the amplifier, in which the processor is configured to execute the steps comprising:
calculating an impedance of the speaker; and
determining an environmental load of the speaker based, at least in part, on the calculated impedance.

9. The apparatus of claim 8, in which the apparatus is a mobile device.

10. The apparatus of claim 9, in which the environmental load is proportional to a force, applied by a user of the mobile device, that causes contact between the mobile device and the user.

11. The apparatus of claim 10, in which the processor is further configured to detect, based at least in part on the determined force, when the mobile device is removed from an ear of the user.

12. The apparatus of claim 8, in which the amplifier is configured to:
apply a voltage to the speaker; and
measure a current through the speaker, and
in which the processor is configured to:
calculate the impedance based, at least in part, on the applied voltage and the measured current.

13. The apparatus of claim 8, in which the processor is a digital signal processor (DSP) and the digital signal processor is configured to adjust an adaptive noise cancellation (ANC) algorithm based, at least in part, on the determined force.

14. The apparatus of claim 13, further comprising:
an error microphone coupled to the digital signal processor,
in which the digital signal processor is further configured to adjust the ANC algorithm based, at least in part, on an audio signal received from the error microphone.

15. The apparatus of claim 8, in which the processor is further configured to linearize an output of the speaker based, at least in part, on the calculated impedance.

16. A computer program product, comprising:
a non-transitory computer readable medium comprising code to execute the steps comprising:
calculating an impedance of a speaker; and
determining an environmental load of the speaker based, at least in part, on the calculated impedance.

17. The computer program product of claim 16, in which the environmental load is proportional to a force, applied by a user of the mobile device, that causes contact between the mobile device and the user.

18. The computer program product of claim 16, in which the medium further comprises code to detect, based at least in part on the determined force, when the mobile device is removed from an ear of the user.

19. The computer program product of claim 16, in which the medium further comprises code to adjust an adaptive noise cancellation (ANC) algorithm based, at least in part, on the determined force.

20. The computer program product of claim 16, in which the medium further comprises code to linearize an output of the speaker based, at least in part, on the calculated impedance.
